(19) United States
(12) Patent Application Publication
(10) Pub. No.: US 2010/0094509 A1
(43) Pub. Date: Apr. 15, 2010

(54) System for Reducing The Braking Distance of a Vehicle

(75) Inventors: Stefan Lüke, Olpe (DE); Jürgen Pfeiffer, Glashutten (DE); Matthias Strauss, Pfungstadt (DE)

Correspondence Address: RATNERPRESTIA, P.O. BOX 980, VALLEY FORGE, PA, 19482, US

(73) Assignee: Continental Teves AG & CO oHG, Frankfurt (DE)

(21) Appl. No.: 12/444,465

(22) PCT Filed: Oct. 12, 2007
(86) PCT No.: PCT/EP2007/060914

§ 371 Date: Dec. 29, 2009

(30) Foreign Application Priority Data
Oct. 13, 2006 (DE) 102006049103.3

(51) Int. Cl. B60W 40/02; G06F 17/50; G01S 13/00

(52) U.S. Cl. 701/45; 703/1; 342/52

(57) ABSTRACT

Method for reducing the stopping distance of a vehicle, wherein data which are received via a vehicle-to-vehicle communication are analysed, and a surroundings analysis for the driver's own vehicle is carried out, and vehicle-specific data are transmitted and integrated into an existing safety concept.

### CROSS REFERENCE TO RELATED APPLICATIONS

This application is the U.S. national phase application of PCT International Application No. PCT/EP2007/060914, filed Oct. 12, 2007, which claims priority to German Patent Application No. DE 102006049103.3, filed Oct. 13, 2006, the contents of such applications being incorporated by reference herein.

### BACKGROUND OF THE INVENTION

1. Field of the Invention

The invention relates to the field of vehicle brakes and relates, in particular, to a system for reducing the braking distance of a vehicle, in which braking is prepared and carried out when a predefined event occurs.

2. Description of the Related Art

EP 1081004 A2 discloses a sensing system of a vehicle which detects obstacles in the direction of travel or near to the direction of travel of the vehicle. Sensors which are mounted on the vehicle supply characteristic parameters for the state of the vehicle. Furthermore, sensors are assigned to the brake pedal and to the accelerator pedal. A control unit determines whether a braking process is necessary, on the basis of the data supplied by the sensing system. Furthermore, the control unit defines a desired “stand-by brake pressure”. This system can accordingly reduce the stopping distance if objects are detected in the area in front of the vehicle.

EP 473866A2 discloses a system in which a sensor senses a plurality of potential collision objects and uses the acquired data to predict, for example, a possible hazard in the form of a collision. In order to avoid the collision it is proposed that braking means and/or steering means be activated by a vehicle control unit.

When braking occurs in emergency situations, the driver must first overcome the clearance of the brake until a brake pressure can be built up in order to bring about an appreciable deceleration of the vehicle. This takes time and lengthens the stopping distance. In order to reduce this so-called build-up time, the brake can be prefilled at a low pressure which still does not cause any appreciable deceleration. When the brake is activated by the driver, it is then not necessary to overcome any clearance anymore. An event at whose occurrence the brake is prefilled is, for example, the rapid removal of the driver's foot from the accelerator pedal. A large number of situations in which the pre-filling of the brake or the build-up of a certain brake pressure is appropriate are not sensed by this event or the monitoring of the accelerator pedal.

A disadvantage with these known systems is that vehicles which are located only in half of the area to the rear of a transmitting vehicle are provided with information and that no precise data are available about the current position of the vehicles in question. The assessment of a risk of collision is therefore also subject to uncertainties. Vehicles which are located in half of the area in front of the transmitting vehicle are not provided with any information even if they are approaching the location of the accident in the oncoming traffic and are confronted with an unexpected risk within a short time.

A stopping distance reduction means was developed within the scope of the APIA project of the applicant. On the basis of a beam sensor, the driver is assisted in initiating a braking process in a hazardous situation in that, when the accelerator pedal is released the brake system is prefilled, a slight deceleration of up to 0.3 g (pre-braking) is initiated during the time in which the driver does not touch any of the pedals, and the braking assistant intervenes earlier owing to relatively low threshold values when the brakes are activated by the driver.

Despite the very good performance of the system, system-related problems arise here, such as the fact that stationary vehicles or objects are not detected by the beam sensors. As a result it is only possible to make a classification with respect to the beam sensor properties of the object, and it is not possible to make one in terms of what the object actually is or whether it is at all an object on the road, next to it, below it or above it. For this reason, owing to the high level of uncertainty it is not possible to initiate any strong autonomous braking processes. Furthermore, carriageway markings are not used in order to ensure an improved situation analysis, and the range of the sensor is continuously limited by vehicles or objects in the surroundings. An important variable such as the coefficient of friction, which is very important for the interventions and warning strategy, is not known from the outset.

### SUMMARY OF THE INVENTION

The invention relates to the object of making available a system which overcomes the described deficiency in the prior art and permits a reduced braking distance.

The system according to aspects of the invention reduces the stopping distance of a vehicle by analysing data which are received via a vehicle-to-vehicle communication, and the surroundings 8 of the vehicle are analysed, and vehicle-specific data are transmitted and integrated into an existing safety concept with a dynamic surroundings model.

The system advantageously adapts the search areas of the radar sensors, lidar sensors or camera sensors which are used for the analysis of the surroundings, by evaluating the dynamic surroundings model, and the system expands and/or adapts the dynamic surroundings model after the adaptation of the search areas by means of the radar sensors, lidar sensors and camera sensors.

The expansion of the dynamic surroundings model, carried out by the system, by adding the objects which are located outside the sensing range of the radar sensors, lidar sensors and camera sensors, by means of the data which are received via a vehicle-to-vehicle communication, is particularly advantageous since this increases the “viewing range”.

In a further advantageous refinement of the system, the data which are received via a vehicle-to-vehicle communication are analysed and evaluated with respect to one of the vehicles located in the direct and indirect surroundings, and speed and/or acceleration profiles which characterize the individual vehicles, wherein the indirect surroundings are determined by the range of the radar sensors, lidar sensors and camera sensors.

By means of the system, the vehicle safety and vehicle assistance systems which are present in the vehicle are advantageously activated by means of the speed and/or acceleration profiles, determined in the dynamic surroundings model, of the vehicles which are located in the direct surroundings.

In a preferred refinement, the search areas of the surrounding sensor system, for example of the radar sensors, lidar sensors or camera sensors, are adapted to the situation which is known from the outset and has been analysed in advance, on the basis of a dynamic surroundings model.

In a further particularly preferred refinement, the acceleration information is analysed and evaluated in order to reduce the reaction time.

According to one further refinement, the surroundings model is expanded by adding the objects which are located outside the sensing range of the beam sensors and video sensors.

The present invention relates to the precondition that hazardous traffic situations, in particular mass pile-ups and accidents in oncoming traffic and intersecting traffic, can be effectively avoided only if as far as possible all of the vehicles which are located in a specific area of the surroundings are included in a safety concept and if the position of all the involved vehicles is made available as precisely as possible.

Accordingly, the present invention provides a system for road traffic which not only includes the vehicles located behind a vehicle travelling in front but also all the vehicles which are located in a specific area surrounding the traffic area. In particular, precise location coordinates which permit the participating vehicles to assess risk more accurately are also made available. Participation in a system of this kind requires that the vehicles be equipped with a locating system and a communication system, such as for example a vehicle-to-vehicle communication system and a GPS receiver, these systems being connected to on-board systems such as a driver assistance system and vehicle safety systems in order to obtain, from the latter, information about interesting data on the vehicle which are of significance for a system which covers a plurality of vehicles.

The participating vehicles expediently have, as vehicle safety systems, electrically actuable brake systems in order to permit the fastest possible intervention in the event of a hazardous situation. If all the involved vehicles have comparable technical equipment, each vehicle may be a data transmitter and/or data receiver. All the vehicles are equipped with a nondirectional radio link which permits broadcast communication in the immediate surroundings. There is also provision that when a specific situation occurs in the surroundings model, point-to-point communications links are set up and maintained if, for example, it is possible to detect that a certain vehicle is approaching other vehicles in such a way that a collision is directly imminent. The exchange of information between the vehicles also comprises, in particular, precise location coordinates. This permits all the driver assistance systems and vehicle safety systems to determine the respective own position of their own vehicle with respect to a hazardous location which has been signalled by a vehicle which is affected by the hazard. For example, all the other vehicles in the surroundings of a vehicle which suddenly decelerates severely are identified and their precise position signalled.

All these vehicles which receive information determine their relative position in relation to the braking vehicle. As a function of this, a decision which contributes to the reduction of risk is then taken on the basis of the local evaluation in a vehicle of the local, temporary grouping. For example, measures are not initiated if the vehicle which receives a warning signal is located in front of or next to the braking vehicle because there is no hazard whatsoever. If the receiving vehicle is at a sufficient distance behind the transmitting vehicle and if one vehicle can be prevented from approaching too closely to the other from behind by means of an ACC system, at most a warning message is issued. In contrast, if a receiving vehicle is in a risk area, for example in the direct vicinity of the transmitting vehicle, an automatic braking intervention can take place in order to prevent a collision. For this purpose, a dynamic surroundings model is generated in the vehicles and it continuously carries out cyclical interrogations of the sensors installed in the vehicle in order to sense the surroundings, the interrogations on the bus systems being correspondingly prioritized, and the prioritization of the interrogation being changed as a function of the dynamically adapted surroundings model in order to associate the data volume with the dynamic conditions prevailing in the actual surroundings.

These and other aspects of the invention are illustrated in detail by way of the embodiments and are described with respect to the embodiments in the following, making reference to the FIGURES.

### BRIEF DESCRIPTION OF THE DRAWINGS

The invention is best understood from the following detailed description when read in connection with the accompanying drawing.

In the drawing:

FIG. 1: shows a sensing range of the radiation and video sensors.

### DETAILED DESCRIPTION OF THE PREFERRED EMBODIMENTS

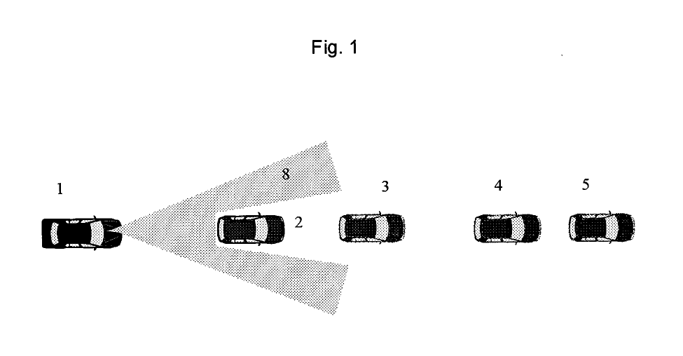

FIG. 1 represents a driving situation in front of a vehicle 1 in which the front vehicle area is monitored by the vehicle 1 by means of the sensors 8. If the vehicle-to-vehicle communication is made use of in addition to the radiation sensors 8, a highly expanded surroundings model which can be adapted dynamically is obtained.

There is no visibility restriction as a result of the vehicle-to-vehicle communication. Data can be exchanged between vehicles and other vehicles or an infrastructure around corners, for example can pass by intersections and other vehicles. A transmitting vehicle no longer has to be identified separately as a vehicle since the type of vehicle is also transmitted, and since stationary vehicles also transmit their position they are also detected.

If a vehicle 3, 4, 5 travelling in front brakes and the traction controller is deployed, the estimated coefficient of friction can also be transmitted and the intervention strategy and warning strategy can be correspondingly adapted. For example, when there is ice on the road it is possible to issue a warning or to intervene significantly earlier and in a more targeted fashion. Basically, all the vehicle data can be transmitted in order to be able to adapt the strategies.

For example, information from other functional components for, for example, the chassis control units such as the active suspension or vertical adjustment systems, can be addressed by the method according to aspects of the invention or the system according to aspects of the invention by means of the dynamic surroundings model.

Standardized, non-optical, radio-based information transmission systems are used as the communication system for the communication between more than two vehicles. The communication system supports different mobile transmission methods which support at least one information distribution in what is referred to as the broadcast mode. In this context, broadcast in a computer-assisted network defines the transmission of a message during which it is transmitted from one point to all the users of a network. It is also alternatively possible to use other transmission modes for the telecommunications technology such as multicast or unicast.

Position-determining systems are used to determine the driver's own position. Suitable position-determining systems are GPS receivers and navigation systems 5. According to aspects of the invention it is also possible to use integrated position-determining systems which combine the functionalities of a GPS receiver and a navigation system in a device.

All the brake systems which are available in the vehicle with electronic control can be used as vehicle safety systems. Vehicle safety systems may be the electronic brake system (EBS) 7, the engine management system (EMS), antiblock brake system (ABS), traction control system (TCS), electronic stability program (ESP), electronic differential lock (EDS), transmission control unit (TCU), traction control system (TCS), electronic braking force distribution (EBD) and/or engine torque controller (ETC).

According to aspects of the invention, the information from the driver assistance systems can also be utilized. Driver assistance systems are additional electronic devices in vehicles for assisting the driver in certain driving situations. These systems intervene in a partially autonomous or autonomous fashion in the drive, or control (for example acceleration system, brake system). Such driver assistance systems are, for example, a parking aid (sensor arrays for detecting an obstacle and inter-vehicle distance), a braking assistant (BAS), cruise controller, adaptive cruise control (ACC) system, inter-vehicle distance warning system, turning-off assistant, traffic jam assistant, lane detection system, lane keeping assistant/lane assistant (lateral guidance support system, lane departure warning (LDW) system), lane keeping support, lane change assistant, lane change support, intelligent speed adaptation (ISA), adaptive bend light, tyre pressure control system, driver state detection system, road sign detection system, platooning, automatic emergency braking system (ANB), assistant for full beam and dipped headlights, and night vision system.

A further example of the effectiveness of the system according to aspects of the invention is the following: a plurality of vehicles are travelling too close one behind the other. The vehicle in front has to brake. The vehicle in the middle reacts too late and drives into the vehicle in front. For the third driver it is no longer possible to brake in good time as a result of the sudden deceleration of the vehicle in front. If the first and last vehicles had had vehicle-to-vehicle communication, the second accident could have been prevented.

Of course, this does not constitute the only application possibility since the expansion of the dynamic surroundings model has positive effects in all conceivable situations in which intervention by an automatic brake system would occur but the necessary sensing range is blocked off by obstacles. In this regard, FIG. 1 shows an example in which the vehicles 3, 4, 5 shown by dashed lines are included in the surroundings model only through vehicle-to-vehicle communication.

Furthermore, in the case of the sensors the search areas are already restricted before an object is detected since the position of the object is already known. By virtue of the transmission of the vehicle data, it is possible for acceleration, deceleration or a change in direction of the other vehicles to be measured directly and it does not have to be interpolated over a plurality of measurements. This results in a significantly shorter reaction time of the overall system since it is then no longer necessary to wait for a plurality of measurements.

In hazardous situations, many drivers depress the brake pedal in a hesitant fashion and waste valuable braking distance. By virtue of the system, for example the vehicle safety system in the embodiment of a braking assistant (BA) system acts in a supportive fashion by virtue of the fact that it also measures, along with the sensors installed in the vehicle, how quickly the brake pedal is activated. The braking assistant system reliably detects from the speed of the pedal whether the driver wishes to initiate full braking. If this is the case, the braking assistant directly makes full brake pressure available in the brake booster if the information that the brake pressure which is requested by the driver is too low from the dynamic surroundings model, is compared. In addition, the signals which are necessary for activation are verified, and necessary measures initiated, via the vehicle-to-vehicle communication and the dynamic surroundings model.

If the driver then slightly releases the pressure on the brake pedal with his foot, the braking assistant immediately becomes inactive. The vehicle safety system in the embodiment of a braking assistant system is composed of a vacuum brake booster (VBB) which can be activated electrically by means of a valve. The travel of the brake pedal is measured indirectly as diaphragm travel of the VBB by means of a resistance potentiometer. The control device is installed directly on the VBB and therefore forms, together with the VBB and the integrated travel potentiometer, one compact overall system. The basic function of the braking device is not influenced by the braking assistant in this context.

The driver's wish for maximum braking is calculated from the speed of the brake pedal. When a certain threshold is reached, which is dependent on the position of the pedal and the vehicle speed, the basic precondition for activation is met. Three further signals are necessary for the activation of the braking assistant: on the one hand, the brake light switch signal, which is supplied by the ABS via the CAN, and the current vehicle speed, which is also supplied via the CAN; on the other hand, the release switch signal which is tapped directly from the booster.

In addition, as a result of the integration of the vehicle-to-vehicle communication, further targets are also taken into account in reducing the stopping distance. These are, in particular, red traffic lights, tight bends and carriageways covered in ice. It is characteristic of these targets that if a vehicle is approaching these targets at an excessively high speed, an ESP intervention takes place, as a result of which the following vehicles classify this target as dangerous if the location and that an ESP intervention of the respective vehicle is transmitted to the vehicles in the surroundings by means of the vehicle-to-vehicle communication, and the dynamic surroundings model is adapted.

In these cases, a warning is also issued to the driver after an analysis of the dynamic surroundings, or an intervention is made directly in the driving behaviour of the vehicle, as is also the case when the stopping distance is reduced through pre-filling, pre-braking and an expanded braking assistant.

The system according to aspects of the invention receives and transmits, by means of the vehicle-to-vehicle communication for the transmission of vehicle-specific data, such as the location, the speed, the acceleration, the steering wheel angle and further important variables and it evaluates the transmitted data in order to identify objects in the road traffic, so as to integrate the latter into an existing safety concept such as reduction of a stopping distance. For this purpose, adaptation of the search areas of the radar sensors, lidar sensors or camera sensors to the situation which is known from the outset is used to prepare a more precise surroundings model so that the reaction time is shortened by evaluating the objects contained in the surroundings model and the acceleration information which describes the objects. The dynamic surroundings model is expanded by adding objects which are located outside the sensing range of the radiation sensors and video sensors. This expansion of an existing safety concept, such as reduction of a stopping distance, by adding an intervention or a warning at hazardous locations or in hazardous situations, such as for example travelling through red traffic lights or driving on dangerous sections of roads too fast, improves safety in road traffic.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-5. (canceled)

6. System for reducing a stopping distance of a vehicle,
wherein data which are received via a vehicle-to-vehicle communication are analysed, and the surroundings of the vehicle are analysed, and vehicle-specific data are transmitted and integrated into an existing safety concept with a dynamic surroundings model.

7. System according to claim 6,
wherein search areas of radar sensors, lidar sensors or camera sensors which are used for the analysis of the surroundings are adapted by evaluating the dynamic surroundings model, and the dynamic surroundings model is adapted, expanded or both expanded and adapted after the adaptation of the search areas by the radar sensors, lidar sensors or camera sensors.

8. System according to claim 7,
wherein the dynamic surroundings model is expanded by adding objects which are located outside of a sensing range of the radar sensors, lidar sensors or camera sensors, by the data which are received via a vehicle-to-vehicle communication.

9. System according to claim 8,
wherein the data which are received via a vehicle-to-vehicle communication are analysed and evaluated with respect to one of the vehicles located in both direct and indirect surroundings, and profiles of speed, acceleration or both speed and acceleration which characterize individual vehicles, wherein the indirect surroundings are determined by the range of the radar sensors, lidar sensors or camera sensors.

10. System according to claim 9,
wherein vehicle safety and vehicle assistance systems which are present in the vehicle are activated by means of the speed profile, the acceleration profile, or both the speed profile and the acceleration profile of the vehicles which are located in the direct surroundings, as determined by the dynamic surroundings model.

11. A method for reducing a stopping distance of a vehicle comprising the steps of:
receiving data via a vehicle-to-vehicle communication;
analyzing the data;
analyzing surroundings of the vehicle, and
transmitting and integrating vehicle-specific data into an existing safety concept with a dynamic surroundings model.
